(19) United States
(12) Patent Application Publication
(10) Pub. No.: US 2026/0177510 A1
(43) Pub. Date: Jun. 25, 2026

(54) CT IMAGE GENERATION METHOD AND TRAINED MODEL GENERATION METHOD

(71) Applicant: SHIMADZU CORPORATION, Kyoto-shi (JP)

(72) Inventors: Zhimin Xie, Kyoto-shi (JP); Tetsuya KOBAYASHI, Kyoto-shi (JP)

(21) Appl. No.: 19/428,208

(22) Filed: Dec. 21, 2025

(30) Foreign Application Priority Data
Dec. 20, 2024 (JP) 2024-225720

(51) Int. Cl. G01N 23/046; G01N 23/083

(52) U.S. Cl. CPC G01N 23/046; G01N 23/083; G01N 2223/3306

(57) ABSTRACT

A CT image generation method comprises: a step of acquiring a plurality of rotational projection image data 30 by performing X-ray imaging while rotating a subject 90; a step of acquiring tomographic image data 31 by performing a reconstruction process based on the acquired plurality of rotational projection image data 30; and a step of acquiring corrected tomographic image data 32, in which blur caused by the rotation of the subject 90 in the tomographic image data 31 is corrected, as output image data 45 by inputting the tomographic image data 31 as input image data 44 to a model 40a.

### TECHNICAL FIELD

The present invention relates to a CT image generation method and a trained model generation method.

### BACKGROUND ART

Conventionally, CT image generation methods are known (see, for example, Patent Literature 1 and Patent Literature 2).

Patent Literature 1 discloses a CT image generation method by an industrial CT (Computed Tomography) scanner used for non-destructive inspection applications. The industrial CT scanner is equipped with an X-ray tube, a detector, a rotating table on which a subject is placed and which is rotatable by a rotation mechanism, and a CPU (Central Processing Unit). The X-ray tube irradiates X-rays toward the subject placed on the rotating table. The detector detects the X-rays irradiated from the X-ray tube. The detector acquires projection image data of the subject that is rotated once by the rotation mechanism. The CPU generates a reconstructed image (CT image) based on the projection image data acquired by the detector.

Also, Patent Literature 2 discloses applying a filter that suppresses rotational blur when generating volume data. Patent Literature 2 discloses that a low-pass filter in the data domain can be modeled as a convolution of two filters: a Gaussian filter and a Top-Hat filter. The Gaussian filter is used to model X-ray source and voxel blur, and the Top-Hat filter is used to model rotational blur. Furthermore, Patent Literature 2 discloses that rotational blur is caused by gantry motion during the integration time of the detection signal by the data acquisition circuit.

### PRIOR ART DOCUMENTS

### Patent Literature

[Patent Literature 1] Japanese Unexamined Patent Application Publication No. S62-284250

[Patent Literature 2] Japanese Unexamined Patent Application Publication No. 2016-198504

### SUMMARY OF THE INVENTION

### Problem to be Solved by the Invention

Although not explicitly stated in Patent Literature 1, a method is practiced wherein multiple projection image data (rotational projection image data) are acquired by irradiating X-rays from an X-ray tube toward a subject while rotating the subject placed on a rotating table. This can shorten the X-ray imaging time for acquiring projection image data compared to intermittent X-ray imaging, where the rotation of the rotating table is stopped for each imaging angle to irradiate X-rays from the X-ray tube toward the subject. However, in X-ray imaging where X-rays are irradiated while rotating the subject, blurring due to the subject's rotation occurs in the acquired projection image data. When a reconstruction process is performed based on such projection image data containing blur, blurring due to the subject's rotation also appears in the acquired volume data and tomographic image data. Moreover, with the method of Patent Literature 2, the effect of reducing the blur caused by the subject's rotation in the tomographic image data is insufficient. Therefore, there is a demand for reducing the blur caused by the subject's rotation in tomographic image data.

The present invention has been made to solve the above problems, and one object of the present invention is to provide a CT image generation method and a trained model generation method capable of reducing blur caused by a subject's rotation in tomographic image data.

### Means for Solving the Problem

A CT image generation method, comprising: a step of acquiring a plurality of rotational projection image data by performing X-ray imaging while rotating a subject; a step of acquiring tomographic image data by performing a reconstruction process based on the acquired plurality of rotational projection image data; and a step of acquiring corrected tomographic image data, in which blur caused by the rotation of the subject in the tomographic image data is corrected, as output image data by inputting the tomographic image data as input image data to a model.

Also, a CT image generation method, comprising: a step of acquiring a plurality of rotational projection image data by performing X-ray imaging while rotating a subject; a step of acquiring intermediate reconstructed image data by performing a reconstruction process multiple times based on the acquired plurality of rotational projection image data and by performing the reconstruction process at an intermediate stage; a step of acquiring corrected reconstructed image data, in which blur caused by the rotation of the subject is corrected, from the acquired intermediate reconstructed image data using a model; and a step of acquiring final reconstructed image data by further performing the reconstruction process using the acquired corrected reconstructed image data, wherein the step of acquiring the corrected reconstructed image data acquires the corrected reconstructed image data, in which the blur caused by the rotation of the subject in the intermediate reconstructed image data is corrected, as output image data by inputting the intermediate reconstructed image data as input image data to the model.

Also, a trained model generation method, comprising: a step of acquiring a training image dataset composed of input training data including tomographic image data of a subject acquired by performing a reconstruction process based on a plurality of rotational projection image data, and output training data including tomographic image data in which blur caused by the rotation of the subject is corrected; and a step of generating, by machine learning based on the input training data and the output training data, a trained model that outputs corrected tomographic image data, in which the blur caused by the rotation of the subject in the tomographic image data is corrected, from the tomographic image data.

### Effects of the Invention

In the first CT image generation method described above, by inputting the tomographic image data, which is based on the rotational projection image data acquired by performing X-ray imaging while rotating the subject, as input image data to the model, it is possible to acquire corrected tomographic image data, in which the blur caused by the rotation of the subject in the tomographic image data is corrected, as output image data. Therefore, even if blur caused by the rotation of the subject occurs in the tomographic image data based on the rotational projection image data, by inputting the tomographic image data to the model, the corrected tomographic image data with the blur caused by the subject's rotation corrected is output from the model as the output result. Thus, it is possible to acquire corrected tomographic image data in which the blur caused by the subject's rotation is corrected. Therefore, it is possible to reduce the blur caused by the subject's rotation in the tomographic image data at any tomographic plane.

Also, in the second CT image generation method described above, by acquiring corrected reconstructed image data, in which blur caused by the rotation of the subject is corrected from the acquired intermediate reconstructed image data, using a model at an intermediate stage of a reconstruction process that is performed multiple times, it is possible to perform the reconstruction process on the corrected reconstructed image data, in which the blur caused by the rotation of the subject is corrected, at the intermediate stage of the reconstruction process. Therefore, as the final reconstructed image data, it is possible to acquire reconstructed image data in which the blur caused by the rotation of the subject is accurately corrected. Therefore, it is possible to reduce the blur caused by the subject's rotation in the tomographic image data at any tomographic plane.

Also, in the trained model generation method, by using machine learning based on the input training data including the tomographic image data of the subject and the output training data including the tomographic image data in which the blur caused by the rotation of the subject is corrected, it is possible to learn image processing that corrects the blur caused by the rotation of the subject. Therefore, it is possible to easily generate a trained model that outputs corrected tomographic image data, in which the blur caused by the rotation of the subject in the tomographic image data is corrected, from the tomographic image data.

### BRIEF DESCRIPTION OF THE DRAWINGS

FIG. 1 is a schematic diagram showing the overall configuration of an X-ray imaging apparatus according to a first embodiment.

FIG. 2 is a diagram showing rotational information image data according to the first embodiment.

FIG. 3 is a diagram for explaining the generation of a trained model and the acquisition of corrected tomographic image data using the trained model according to the first embodiment.

FIG. 4 is a diagram for explaining the control of acquiring corrected tomographic image data using the trained model according to the first embodiment.

FIG. 5 is a flowchart for explaining the processing of the CT image generation method according to the first embodiment.

FIG. 6 is a flowchart for explaining the processing of the trained model generation method according to the first embodiment.

FIG. 7 is a diagram for explaining a comparison result between corrected tomographic image data acquired by the CT image generation method in the first embodiment and corrected tomographic image data acquired by a CT image generation method in a modification of the first embodiment.

FIG. 8 is a schematic diagram showing the overall configuration of an X-ray imaging apparatus according to a second embodiment.

FIG. 9 is a diagram for explaining the generation of a trained model and the acquisition of corrected tomographic image data using the trained model according to the second embodiment.

FIG. 10 is a flowchart for explaining the processing of the CT image generation method according to the second embodiment.

FIG. 11 is a flowchart for explaining the processing of the trained model generation method according to the second embodiment.

FIG. 12 is a diagram for explaining a comparison result between corrected tomographic image data acquired by the CT image generation method in the second embodiment and corrected tomographic image data acquired by a CT image generation method in a modification of the second embodiment.

FIG. 13 is a schematic diagram showing the overall configuration of an X-ray imaging apparatus according to a third embodiment.

FIG. 14 is a diagram for explaining the reconstruction process according to the third embodiment.

FIG. 15 is a flowchart for explaining the processing of the CT image generation method according to the third embodiment.

FIG. 16 is a diagram for explaining the effect of the final reconstructed image data acquired by the CT image generation method in the third embodiment.

### DESCRIPTION OF EMBODIMENTS

Hereinafter, embodiments embodying the present invention will be described based on the drawings.

### First Embodiment

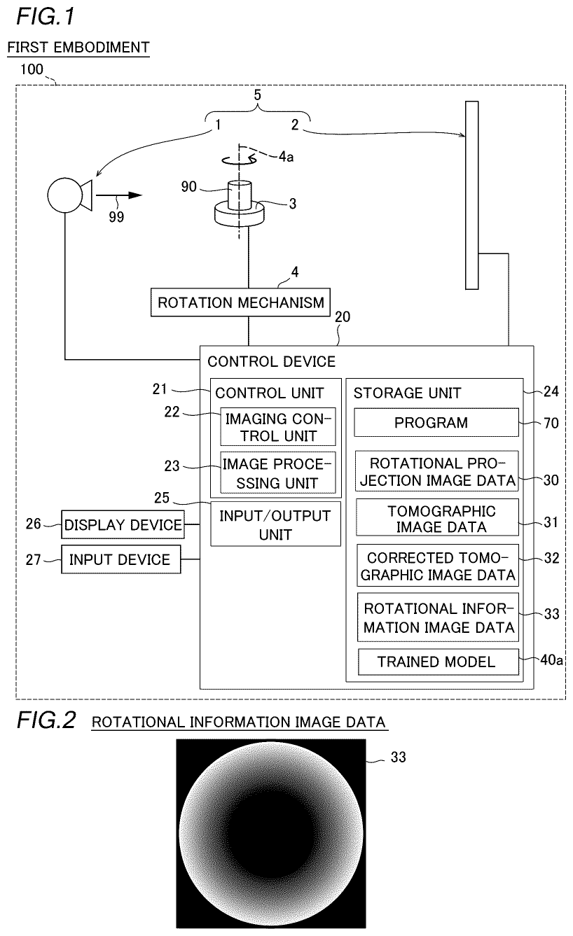

With reference to FIG. 1, the overall configuration of an X-ray imaging apparatus 100 according to a first embodiment will be described.

As shown in FIG. 1, the X-ray imaging apparatus 100 is an apparatus that captures X-ray images of a subject 90 and generates CT images. The X-ray imaging apparatus 100 of the first embodiment is used, for example, for non-destructive inspection applications. The subject 90 to be inspected is not particularly limited. The X-ray imaging apparatus 100 acquires rotational projection image data 30 (X-ray image data) of the subject 90 from the entire circumference of a subject placement unit 3 on which the subject 90 is placed, and constructs a tomographic image (CT image) based on the acquired rotational projection image data 30.

The X-ray imaging apparatus 100 includes an X-ray tube 1, a detector 2, a subject placement unit 3, a rotation mechanism 4, and a control device 20. The X-ray tube 1 and the detector 2 constitute an imaging unit 5 that captures X-ray images.

The X-ray tube 1 is configured to irradiate X-rays 99 onto the subject 90 placed on the subject placement unit 3. Specifically, the X-ray tube 1 continuously irradiates X-rays 99 toward the subject 90, which is rotated by the rotation of the subject placement unit 3 on which the subject 90 is placed. The X-ray tube 1 is configured to generate X-rays 99 when a high voltage is applied. The X-ray tube 1 faces the detector 2 via the subject placement unit 3. The X-ray tube 1, the subject placement unit 3, and the detector 2 are arranged side by side in the horizontal direction.

The detector 2 is configured to detect the X-rays 99 emitted from the X-ray tube 1. The X-rays 99 emitted from the X-ray tube 1 pass through the subject 90 and enter the detection surface of the detector 2. The detector 2 is configured to convert the detected X-rays 99 into electrical signals. This provides an X-ray image reflecting the transmission of X-rays 99 through the subject 90. The detector 2 is, for example, an FPD (Flat Panel Detector). The detector 2 is composed of a plurality of conversion elements (not shown) and pixel electrodes (not shown) arranged on the plurality of conversion elements. The plurality of conversion elements and pixel electrodes are arranged in a matrix in the detection plane at a predetermined period (pixel pitch). The detection signals (image signals) of the detector 2 are sent to an image processing unit 23.

The subject placement unit 3 is disposed between the X-ray tube 1 and the detector 2 and is configured to have the subject 90 placed on it. The subject placement unit 3 is constituted by a subject stage on which the subject 90 is placed.

The rotation mechanism 4 rotates one of the imaging unit 5, which includes the X-ray tube 1 and the detector 2, and the subject placement unit 3. The rotation mechanism 4 rotates one of the imaging unit 5 and the subject placement unit 3 around a rotation axis 4a. In the first embodiment, the rotation mechanism 4 rotates the subject placement unit 3 in a horizontal plane around the rotation axis 4a. The rotation mechanism 4 does not rotate the imaging unit 5. The rotation axis 4a passes through the subject placement unit 3 and is aligned with the vertical direction. The rotation axis 4a is orthogonal to a straight line (a representative line of the X-ray flux) extending from the X-ray tube 1 through the subject 90 on the subject placement unit 3 to the detector 2. The rotation mechanism 4 includes a motor (not shown) and a speed reducer (not shown) for rotating the subject placement unit 3.

The rotation mechanism 4 does not stop the rotation of the subject placement unit 3, on which the subject 90 is placed, during the continuous irradiation of X-rays 99 by the X-ray tube 1. That is, the subject placement unit 3 on which the subject 90 is placed is rotated by the rotation mechanism 4, and X-rays 99 are continuously irradiated by the X-ray tube 1, thereby capturing X-ray images of the subject 90 while rotating it.

The control device 20 includes a control unit 21, a storage unit 24, and an input/output unit 25. The control device 20 is configured, for example, by a PC (personal computer). The control device 20 is connected to a display device 26 and an input device 27.

The control unit 21 is a computer including a CPU (Central Processing Unit), a GPU (Graphics Processing Unit), a ROM (Read Only Memory), and a RAM (Random Access Memory). The control unit 21 performs predetermined control by the CPU executing a predetermined program 70. The control unit 21 includes, as functional components, an imaging control unit 22 and an image processing unit 23. That is, the control unit 21 functions as the imaging control unit 22 and the image processing unit 23 by the CPU executing the predetermined program 70.

The imaging control unit 22, by executing the program 70 stored in the storage unit 24, sets imaging conditions in the X-ray imaging apparatus 100 and controls the start and stop of X-ray imaging. That is, the imaging control unit 22 controls the operation of the X-ray tube 1. Also, the imaging control unit 22 controls the operation of the rotation mechanism 4.

The image processing unit 23 acquires a plurality of rotational projection image data 30 from the detector 2. The image processing unit 23 generates the plurality of rotational projection image data 30 from the detection signals (image signals) of the detector 2. As described above, the subject 90 is subjected to X-ray imaging by the imaging unit 5 while being rotated. The image processing unit 23 acquires the plurality of rotational projection image data 30 based on the detection signals (image signals) acquired by the detector 2 by performing X-ray imaging while rotating the subject 90.

The image processing unit 23 acquires from the detector 2 a plurality of rotational projection image data 30 at each of a plurality of imaging angles, which are set based on the rotation speed of the subject placement unit 3 by the rotation mechanism 4 and the frame rate (number of frames per second). The rotational projection image data 30 is data of an X-ray image acquired for each imaging angle. The acquisition of the rotational projection image data 30 for each imaging angle is performed over a predetermined preset angle range. The predetermined preset angle range is 360 degrees (one rotation). Also, a number of rotational projection image data 30 corresponding to a preset frame rate is acquired. Note that the predetermined preset angle range is not limited to 360 degrees (one rotation) and is not particularly limited as long as it is 180 degrees (half a rotation) or more.

The image processing unit 23 acquires tomographic image data 31 by performing a reconstruction process based on the acquired plurality of rotational projection image data 30. The tomographic image data 31 may be adopted as tomographic image data 31 obtained by cutting the rotational projection image data 30 at an arbitrary position. In the present embodiment, preferably, the tomographic image data 31 is a tomographic image cut in a direction perpendicular to the rotation axis of the subject 90. This is because this tomographic image has a particularly large degree of blur caused by the rotation of the subject 90, and thus the effect of blur correction of the present invention is significant. Note that 3D volume data can also be constructed by stacking a plurality of tomographic image data 31. The image processing unit 23 generates the tomographic image data 31 by executing a reconstruction process on a set of rotational projection image data 30 for 360 degrees of imaging angles (referred to as a projection dataset).

The image processing unit 23, as an example, executes a reconstruction process using an iterative approximation method. Note that the reconstruction process is not limited to a reconstruction process using an iterative approximation method, and any known reconstruction process can be performed. The reconstruction process may be, for example, a reconstruction process by an analytical method using the FDK method, or a reconstruction process by another analytical method other than the FDK method.

The image processing unit 23 acquires rotational information image data 33 (see FIG. 2). The rotational information image data 33 is image data reflecting the rotational information of the subject 90 when acquiring the plurality of rotational projection image data 30. Details of the rotational information image data 33 will be described later.

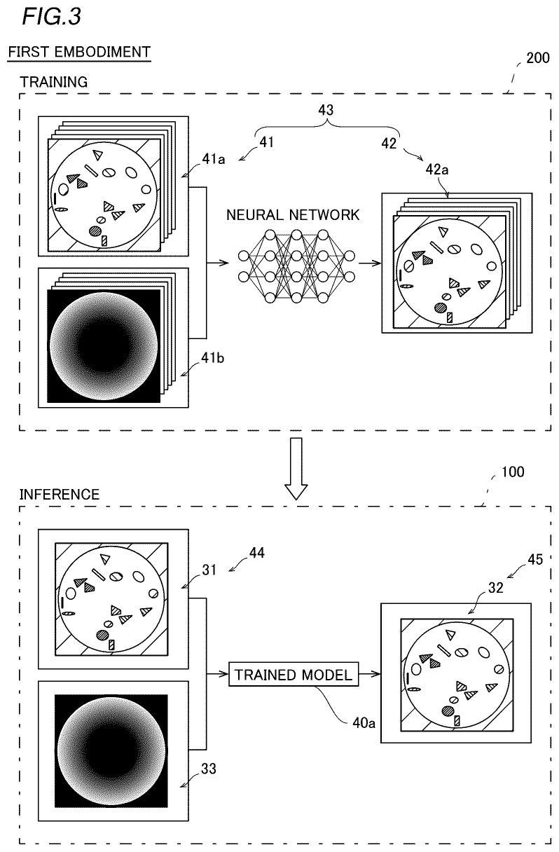

As shown in FIG. 3, the image processing unit 23 acquires corrected tomographic image data 32 as output image data 45 by inputting the tomographic image data 31 as input image data 44 to a trained model 40a stored in the storage unit 24. The corrected tomographic image data 32 is image data in which the blur caused by the rotation of the subject 90 in the tomographic image data 31 has been corrected. In the first embodiment, the image processing unit 23 acquires the corrected tomographic image data 32, in which the blur caused by the rotation of the subject 90 in the tomographic image data 31 is corrected, as the output image data 45 by inputting the tomographic image data 31 and the rotational information image data 33 as the input image data 44 to the trained model 40a. That is, the image processing unit 23 acquires the corrected tomographic image data 32 as an output result (inference result) by inputting the tomographic image data 31 and the rotational information image data 33 as the input image data 44 to the trained model 40a. Details of the trained model 40a will be described later. The trained model 40a is an example of the “model” in the claims.

As shown in FIG. 1, the storage unit 24 is configured to include a volatile storage device and a non-volatile storage device. The storage unit 24 stores a program 70, various setting information (not shown) related to X-ray image capturing of the X-ray imaging apparatus 100, rotational information image data 33, the trained model 40a, and the like. Also, the storage unit 24 stores the acquired plurality of rotational projection image data 30, the tomographic image data 31 generated based on the rotational projection image data 30, and the corrected tomographic image data 32 generated using the trained model 40a.

The input/output unit 25 is configured by various interfaces for inputting and outputting signals to and from the control device 20. The input/output unit 25 is connected to the display device 26 and the input device 27. The display device 26 is, for example, a liquid crystal display device. The input device 27 includes a keyboard, a mouse, and the like. The image processing unit 23 acquires detection signals (image signals) from the detector 2 via the input/output unit 25.

### Rotational Information Image Data

With reference to FIG. 2, the rotational information image data 33 will be described. The image processing unit 23 acquires the rotational information image data 33, which reflects the rotational information of the subject 90. That is, the image processing unit 23 generates the rotational information image data 33, which reflects the rotational information of the subject 90.

Specifically, the rotational information image data 33 is image data for each pixel of the tomographic image data 31 after the reconstruction process, reflecting the rotational information of the subject 90 when acquiring the plurality of rotational projection image data 30. The rotational information of the subject 90 includes the rotation speed of the subject 90 and the rotation angle of the subject 90. That is, the rotational information image data 33 is movement amount image data indicating the movement amount of each pixel in the tomographic image data 31, based on the rotation speed of the subject 90 as rotational information and the rotation angle of the subject 90 between the plurality of rotational projection image data 30.

The rotation speed of the subject 90 is the rotation speed of the subject 90 when acquiring the plurality of rotational projection image data 30. That is, the rotation speed of the subject 90 is the amount of rotation per unit time of the subject placement unit 3 by the rotation mechanism 4 when acquiring the plurality of rotational projection image data 30. The rotation speed of the subject placement unit 3 by the rotation mechanism 4 may be set before acquiring the plurality of rotational projection image data 30, or may be set as a fixed value of the X-ray imaging apparatus 100.

The rotation angle of the subject 90 is the rotation angle of the subject 90 between the plurality of rotational projection image data 30, based on the frame rate set before acquiring the plurality of rotational projection image data 30. That is, the rotation angle of the subject 90 is the rotation angle of the subject placement unit 3 around the rotation axis 4a between the acquired rotational projection image data 30 and the next acquired rotational projection image data 30.

Here, when acquiring the rotational projection image data 30 while continuously irradiating the rotating subject 90 with X-rays 99, blur due to the rotation of the subject 90 (subject motion blur) occurs in the acquired rotational projection image data 30. That is, the movement of the subject 90 during the capture of one piece of rotational projection image data 30 appears as blur of the subject 90 (subject motion blur) in the acquired single piece of rotational projection image data 30. Then, when a reconstruction process is performed based on the rotational projection image data 30 containing the blur due to the rotation of the subject 90 (subject motion blur), the blur due to the rotation of the subject 90 (subject motion blur) also appears in the tomographic image data 31 at any cutting plane acquired by the reconstruction process. In other words, in the tomographic image data 31 acquired by the reconstruction process, a part of the subject becomes blurred due to the rotation of the subject 90.

The rotational information image data 33 indicates the movement amount of the subject 90 at each pixel of the tomographic image data 31 acquired by the reconstruction process. That is, the rotational information image data 33 indicates the amount that a pixel at each pixel position moves per unit time. In the rotational information image data 33, darker parts (dark parts, parts close to black) indicate that the movement amount of the pixel is small, and lighter parts (bright parts, parts close to white) indicate that the movement amount of the pixel is large.

The central portion of the rotational information image data 33 is the center of rotation of the subject 90, so there is almost no movement of the pixels. That is, the central part of the rotational information image data 33 is dark in color. In contrast, in the rotational information image data 33, as the distance from the central portion increases and approaches the portion corresponding to the outer peripheral portion of the subject 90, the movement amount of the pixels becomes larger. That is, in the rotational information image data 33, the color becomes lighter as the distance from the central portion increases and approaches the portion corresponding to the outer peripheral portion of the subject 90. Note that the portion corresponding to the outside of the subject 90 in the rotational information image data 33 is black because there is no pixel movement due to no rotation.

The rotational information image data 33 indicates the movement amount of the subject 90 at each pixel of the tomographic image data 31 acquired by the reconstruction process, and does not include the movement direction of the subject 90 at each pixel of the tomographic image data 31 acquired by the reconstruction process. However, since the central portion of the rotational information image data 33 is the center of rotation of the subject 90, the movement direction of the subject 90 at each pixel is automatically determined based on the rotation direction of the subject 90.

The rotation speed of the subject 90 and the rotation angle of the subject 90 between the plurality of rotational projection image data 30 are set before the start of X-ray imaging by the imaging unit 5 for acquiring the plurality of rotational projection image data 30. The image processing unit 23 acquires the rotational information image data 33 based on the set rotation speed of the subject 90 and the rotation angle of the subject 90 between the plurality of rotational projection image data 30. The image processing unit 23 acquires the rotational information image data 33 for each X-ray imaging of the subject 90, based on the set rotation speed of the subject 90 and the rotation angle of the subject 90 between the plurality of rotational projection image data 30.

Note that the acquisition of the rotational information image data 33 by the image processing unit 23 may be performed at any time, as long as it is before the acquisition of the corrected tomographic image data 32 using the trained model 40a. The acquisition of the rotational information image data 33 by the image processing unit 23 may be, for example, before the start of X-ray imaging by the imaging unit 5, after the acquisition of the plurality of rotational projection image data 30 by the image processing unit 23, or after the acquisition of the tomographic image data 31 by the execution of the reconstruction process by the image processing unit 23.

### Trained Model and Trained Model Generation Method

As shown in FIG. 3, the trained model 40a outputs corrected tomographic image data 32, in which the blur caused by the rotation of the subject 90 in the tomographic image data 31 is corrected, as output image data 45, when the tomographic image data 31 and the rotational information image data 33 are input as input image data 44.

The method for generating the trained model 40a comprises a step of acquiring a training image dataset 43 composed of input training data 41 including tomographic image data 41a of the subject 90 acquired by performing a reconstruction process based on a plurality of rotational projection image data 30, and output training data 42 including tomographic image data 42a (ground truth image data) in which blur caused by the rotation of the subject 90 is corrected; and a step of generating, by machine learning based on the input training data 41 and the output training data 42, the trained model 40a that outputs corrected tomographic image data 32, in which the blur caused by the rotation of the subject 90 in the tomographic image data 31 is corrected, from the tomographic image data 31.

That is, in the first embodiment, the method for generating the trained model 40a comprises a step of acquiring a training image dataset 43 composed of input training data 41 including tomographic image data 41a of the subject 90 acquired by performing a reconstruction process based on a plurality of rotational projection image data 30 and rotational information image data 41b of the subject 90, and output training data 42 including tomographic image data 42a (ground truth image data) in which blur caused by the rotation of the subject 90 is corrected; and a step of generating, by machine learning based on the input training data 41 and the output training data 42, the trained model 40a that outputs corrected tomographic image data 32, in which the blur caused by the rotation of the subject 90 in the tomographic image data 31 is corrected, from the tomographic image data 31.

The tomographic image data 41a in the input training data 41 includes a plurality of tomographic image data 41a. The plurality of tomographic image data 41a include blur caused by the rotation of the subject 90. Also, the rotational information image data 41b in the input training data 41 includes a plurality of rotational information image data 41b corresponding to each of the plurality of tomographic image data 41a in the input training data 41. Also, the tomographic image data 42a (ground truth image data) with corrected blur caused by the rotation of the subject 90 in the output training data 42 includes a plurality of tomographic image data 42a (ground truth image data) with corrected blur caused by the rotation of the subject 90 corresponding to each of the plurality of tomographic image data 41a in the input training data 41.

The trained model 40a is generated by machine learning using the input training data 41, which includes the tomographic image data 41a of the subject 90 acquired by performing a reconstruction process based on a plurality of rotational projection image data 30 and the rotational information image data 41b of the subject 90, and the output training data 42, which includes the tomographic image data 42a (ground truth image data) with corrected blur caused by the rotation of the subject 90.

The trained model 40a is generated in advance by a learning device 200 separate from the X-ray imaging apparatus 100. The learning device 200 is, for example, a computer for machine learning including a CPU, GPU, ROM, RAM, and the like. The learning device 200 is provided outside the X-ray imaging apparatus 100. Note that the learning device 200 may be provided in the X-ray imaging apparatus 100.

The tomographic image data 41a in the input training data 41 may be the tomographic image data 31 acquired by the image processing unit 23 of the X-ray imaging apparatus 100 and stored in the storage unit 24, or it may be tomographic image data 31 stored in the storage unit 24 of another X-ray imaging apparatus 100 or in the learning device 200. Similarly, the rotational information image data 41b in the input training data 41 may be the rotational information image data 33 acquired by the image processing unit 23 of the X-ray imaging apparatus 100 and stored in the storage unit 24, or it may be rotational information image data 33 stored in the storage unit 24 of another X-ray imaging apparatus 100 or in the learning device 200. The rotational information image data 41b in the input training data 41 may be acquired (generated) by the learning device 200 to correspond to the tomographic image data 41a.

Also, the output training data 42 is the tomographic image data 42a (ground truth image data) in which the blur caused by the rotation of the subject 90 has been corrected. However, the output training data 42 may be tomographic image data of the subject 90 generated based on three-dimensional CAD (Computer-Aided Design) data of the subject 90, or it may be tomographic image data of an actual sectioned subject 90. The output training data 42 may be stored in the storage unit 24 of the X-ray imaging apparatus 100, or it may be stored in the storage unit 24 of another X-ray imaging apparatus 100 or in the learning device 200.

The learning device 200 performs learning by machine learning, with the input training data 41 including the tomographic image data 41a of the subject 90 and the rotational information image data 41b of the subject 90 as input, and the output training data 42 including the tomographic image data 42a (ground truth image data) with corrected blur caused by the rotation of the subject 90 as output, to generate the trained model 40a. That is, the learning device 200 uses the training image dataset 43, which is composed of the input training data 41 and the output training data 42, as training data (a training set) to train the trained model 40a by machine learning.

In the first embodiment, U-Net++, a type of Fully Convolutional Network (FCN), is used as the machine learning method for the trained model 40a. Note that the machine learning method is not limited to U-Net++, and any method such as U-Net, neural networks, support vector machines (SVM), boosting, etc., can be used. The created trained model 40a is stored in the storage unit 24 of the X-ray imaging apparatus 100 via a network (not shown) or a recording medium such as a flash memory.

### Control of Acquiring Corrected Tomographic Image Data Using the Trained Model

The image processing unit 23 does not execute the acquisition of the corrected tomographic image data 32 using the trained model 40a when the rotation speed of the subject 90 in the rotational information image data 33 is less than a predetermined threshold, and executes it when the rotation speed of the subject 90 in the rotational information image data 33 is equal to or greater than the predetermined threshold. That is, the image processing unit 23 does not execute the acquisition of the corrected tomographic image data 32 using the trained model 40a when the acquired rotation speed of the subject placement unit 3 is less than a predetermined threshold at the time of acquiring the rotational information image data 33, and executes it when the acquired rotation speed of the subject placement unit 3 is equal to or greater than the predetermined threshold.

Note that the image processing unit 23 may not acquire the rotational information image data 33 when the acquired rotation speed of the subject 90 (rotation speed of the subject placement unit 3) is less than the predetermined threshold. That is, the image processing unit 23 may not generate the rotational information image data 33 when the acquired rotation speed of the subject 90 (rotation speed of the subject placement unit 3) is less than the predetermined threshold.

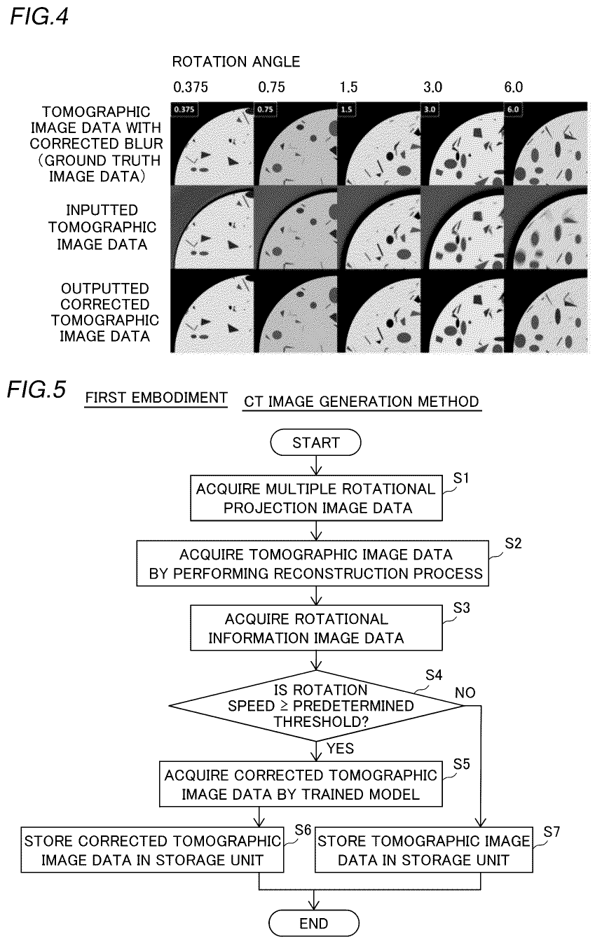

The upper part of FIG. 4 is an example of the tomographic image data 42a (ground truth image data) in which the blur caused by the rotation of the subject 90 has been corrected. The middle part of FIG. 4 is an example of a plurality of tomographic image data 31 with different rotation speeds (rotation angles of the subject 90 between the plurality of rotational projection image data 30 corresponding to the rotation speeds) input to the trained model 40a. The lower part of FIG. 4 is an example of the corrected tomographic image data 32 with the blur caused by the rotation of the subject 90 corrected, output from the trained model 40a.

As shown in FIG. 4, it can be seen that when the rotation speed is equal to or greater than a predetermined threshold (that is, when the rotation angle is 0.75 degrees or more), the effect of correcting the blur caused by the rotation of the subject 90 becomes significant. Therefore, the image processing unit 23 does not execute the acquisition of the corrected tomographic image data 32 using the trained model 40a when the rotation speed of the subject 90 is less than the predetermined threshold (that is, when the rotation angle is less than 0.75 degrees), and executes it when the rotation speed of the subject 90 in the rotational information image data 33 is equal to or greater than the predetermined threshold (that is, when the rotation angle is 0.75 degrees or more). Note that the predetermined threshold for the rotation speed of the subject 90 (rotation angle) is not limited to the rotation speed at a rotation angle of 0.75 degrees and can be set appropriately.

Note that when the rotation speed of the subject 90 is less than the predetermined threshold, instead of acquiring the corrected tomographic image data 32 using the trained model 40a, the image processing unit 23 may execute a known filtering process on the tomographic image data 31, which has a reduced processing time and processing load compared to the output processing of the corrected tomographic image data 32 using the trained model 40a. As a known filtering process, for example, a smoothing filter may be used.

### CT Image Generation Method

Next, with reference to FIG. 5, the CT image generation method by the control unit 21 in the first embodiment will be described. Note that the order of the processing steps can be changed or executed simultaneously as long as they do not contradict each other.

In step S1, the image processing unit 23 acquires a plurality of rotational projection image data 30, which are acquired by performing X-ray imaging by the imaging unit 5 while rotating the subject 90. Then, the process proceeds to step S2.

In step S2, the image processing unit 23 acquires tomographic image data 31 by performing a reconstruction process based on the acquired plurality of rotational projection image data 30. Then, the process proceeds to step S3.

In step S3, the image processing unit 23 acquires rotational information image data 33 that reflects the rotational information of the subject 90 when acquiring the plurality of rotational projection image data 30. Then, the process proceeds to step S4.

In step S4, the image processing unit 23 determines whether or not the rotation speed of the subject 90 in the rotational information image data 33 is equal to or greater than a predetermined threshold. If the rotation speed of the subject 90 in the rotational information image data 33 is equal to or greater than the predetermined threshold (Yes in step S4), the process proceeds to step S5. If the rotation speed of the subject 90 in the rotational information image data 33 is less than the predetermined threshold (No in step S4), the process proceeds to step S7.

In step S5, the image processing unit 23 acquires corrected tomographic image data 32, in which the blur caused by the rotation of the subject 90 in the tomographic image data 31 is corrected, as output image data 45 by inputting the tomographic image data 31 and the rotational information image data 33 as input image data 44 to the trained model 40a. Then, the process proceeds to step S6.

In step S6, the image processing unit 23 stores the acquired corrected tomographic image data 32 in the storage unit 24. Then, the process ends.

In step S7, the image processing unit 23 stores the acquired tomographic image data 31 in the storage unit 24 without acquiring the corrected tomographic image data 32 using the trained model 40a. Then, the process ends.

### Trained Model Generation Method

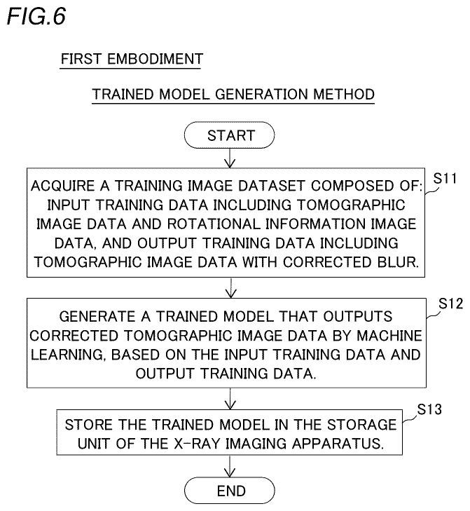

Next, with reference to FIG. 6, the method for generating the trained model 40a by the learning device 200 in the first embodiment will be described. Note that the order of the processing steps can be changed or executed simultaneously as long as they do not contradict each other.

In step S11, the learning device 200 acquires a training image dataset 43 composed of input training data 41 including tomographic image data 41a of the subject 90 acquired by performing a reconstruction process based on a plurality of rotational projection image data 30 and rotational information image data 41b corresponding to the tomographic image data 41a of the subject 90, and output training data 42 including tomographic image data 42a (ground truth image data) in which blur caused by the rotation of the subject 90 is corrected. Then, the process proceeds to step S12.

In step S12, the learning device 200 generates, by machine learning based on the input training data 41 and the output training data 42, the trained model 40a that outputs corrected tomographic image data 32, in which the blur caused by the rotation of the subject 90 in the tomographic image data 31 is corrected, from the tomographic image data 31. Then, the process proceeds to step S13.

In step S13, the X-ray imaging apparatus 100 stores the trained model 40a generated by the learning device 200 in the storage unit 24 of the X-ray imaging apparatus 100. Then, the process ends.

### Comparison between First Embodiment and Modification of First Embodiment

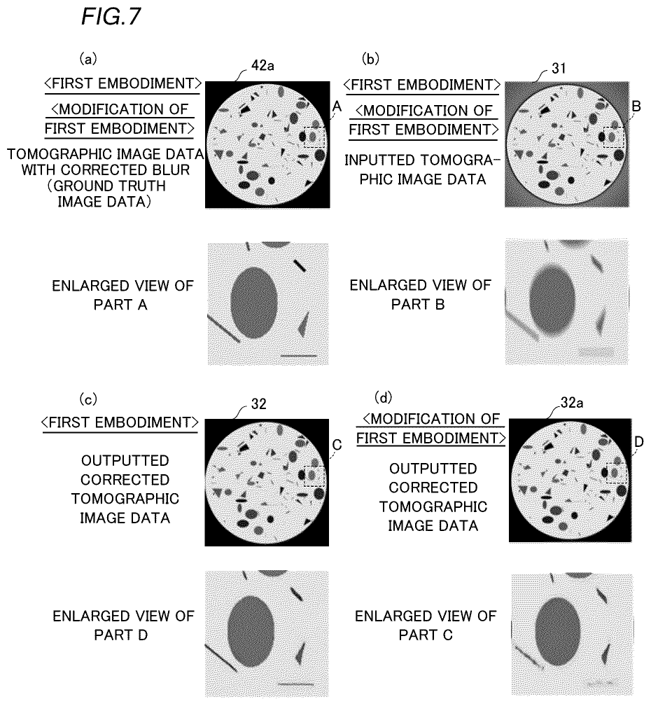

With reference to FIG. 3 and FIG. 7(a) to 7(d), a comparison result between the corrected tomographic image data 32 (CT image) acquired by the CT image generation method in the first embodiment and the corrected tomographic image data 32a (CT image) acquired by the CT image generation method in a modification of the first embodiment will be described.

The CT image generation method in the modification of the first embodiment, unlike the CT image generation method in the first embodiment shown in FIG. 3, acquires corrected tomographic image data 32a (see FIG. 7(d)) as output image data 45 by inputting only the tomographic image data 31 as input image data 44 to the trained model, without inputting the rotational information image data 33. Also, the trained model in the modification of the first embodiment, unlike the CT image generation method in the first embodiment shown in FIG. 3, is generated by machine learning based on a training image dataset 43 composed of input training data 41 including the tomographic image data 41a of the subject 90, without including the rotational information image data 41b, and output training data 42 which is the tomographic image data 42a (ground truth image data) with corrected blur caused by the rotation of the subject 90. Note that the trained model in the modification of the first embodiment is an example of the “model” in the claims.

The subject 90 in the CT image generation method of the first embodiment and the subject 90 in the CT image generation method of the modification of the first embodiment are the same subject 90. The subject 90 is a cylindrical sample made of resin, and the interior of the subject 90 includes a material with a low X-ray 99 absorption coefficient or a gap.

The upper part of FIG. 7(a) is the tomographic image data 42a (ground truth image data) with corrected blur caused by the rotation of the subject 90 in the first embodiment and the modification of the first embodiment, and the lower part of FIG. 7(a) is an enlarged view of portion A in the upper part of FIG. 7(a). The upper part of FIG. 7(b) is the tomographic image data 31 (see FIG. 3) acquired by performing a reconstruction process based on a plurality of rotational projection image data 30 (see FIG. 3) in the first embodiment and the modification of the first embodiment, and the lower part of FIG. 7(b) is an enlarged view of portion B in the upper part of FIG. 7(b). The upper part of FIG. 7(c) is the corrected tomographic image data 32 (see FIG. 3) of the first embodiment, and the lower part of FIG. 7(c) is an enlarged view of portion C in the upper part of FIG. 7(c). The upper part of FIG. 7(d) is the corrected tomographic image data 32a of the modification of the first embodiment, and the lower part of FIG. 7(d) is an enlarged view of portion D in the upper part of FIG. 7(d).

Comparing the lower part of FIG. 7(c) and the lower part of FIG. 7(d), it can be confirmed that the corrected tomographic image data 32 of the first embodiment shown in the lower part of FIG. 7(c) has the blur caused by the rotation of the subject 90 more corrected than the corrected tomographic image data 32a of the modification of the first embodiment shown in the lower part of FIG. 7(d). Therefore, it can be confirmed that the CT image generation method in the first embodiment can reduce the blur caused by the rotation of the subject 90 in the tomographic image data at any cutting plane more than the CT image generation method in the modification of the first embodiment.

### Second Embodiment

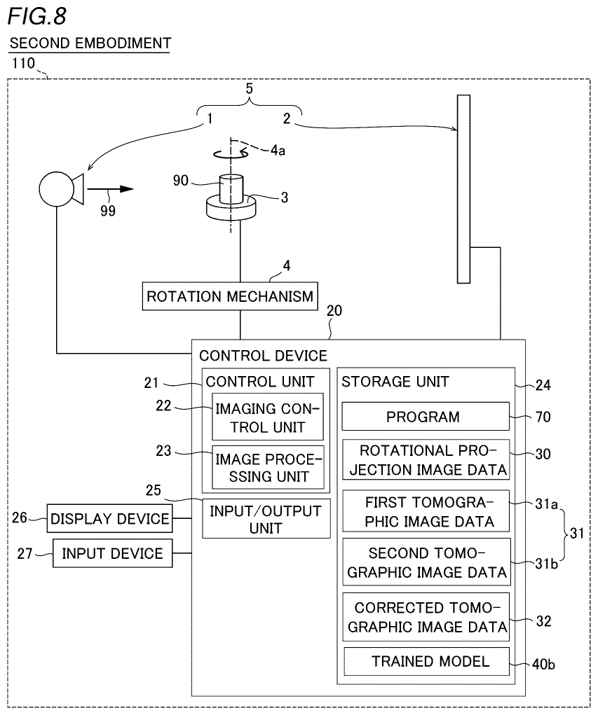

Next, with reference to FIGS. 8 to 12, a CT image generation method and a method for generating a trained model 40b according to a second embodiment will be described. In the second embodiment, an example will be described in which corrected tomographic image data 32 is acquired as output image data 45 by inputting a plurality of tomographic image data 31 with different degrees of noise as input image data 44 to the trained model 40b. In the second embodiment, components similar to those in the first embodiment described above are denoted by the same reference numerals, and a description thereof will be omitted. Note that the trained model 40b is an example of the “model” in the claims.

As shown in FIG. 8, in the second embodiment, the image processing unit 23 acquires a plurality of tomographic image data 31 with different degrees of noise in the reconstruction process based on the acquired plurality of rotational projection image data 30. In the second embodiment, the image processing unit 23, as an example, acquires two types of tomographic image data 31 with different degrees of smoothing in the reconstruction process based on the acquired plurality of rotational projection image data 30.

The two types of tomographic image data 31 with different degrees of smoothing are acquired, as an example, by processing the acquired tomographic image data 31 with two smoothing filters having different smoothing strengths in the reconstruction process. As the smoothing filter, a known smoothing filter such as a Gaussian filter can be used.

The smoothing strength can be increased or decreased by varying the kernel size (filter size) of the filter function used. One of the two smoothing filters with different smoothing strengths is a first smoothing filter whose smoothing strength is increased by making the kernel size larger. Increasing the smoothing strength makes the change in pixel values between pixels smoother. The other of the two smoothing filters with different smoothing strengths is a second smoothing filter whose smoothing strength is made smaller than that of the first smoothing filter by making the kernel size smaller. Note that the smoothing filter is not limited to a Gaussian filter and may be, for example, a low-pass filter.

In the reconstruction process, the image processing unit 23 acquires first tomographic image data 31a with a high smoothing strength by performing a smoothing process with the first smoothing filter on the acquired tomographic image data 31. Also, in the reconstruction process, the image processing unit 23 acquires second tomographic image data 31b with a low smoothing strength by performing a smoothing process with the second smoothing filter on the acquired tomographic image data 31.

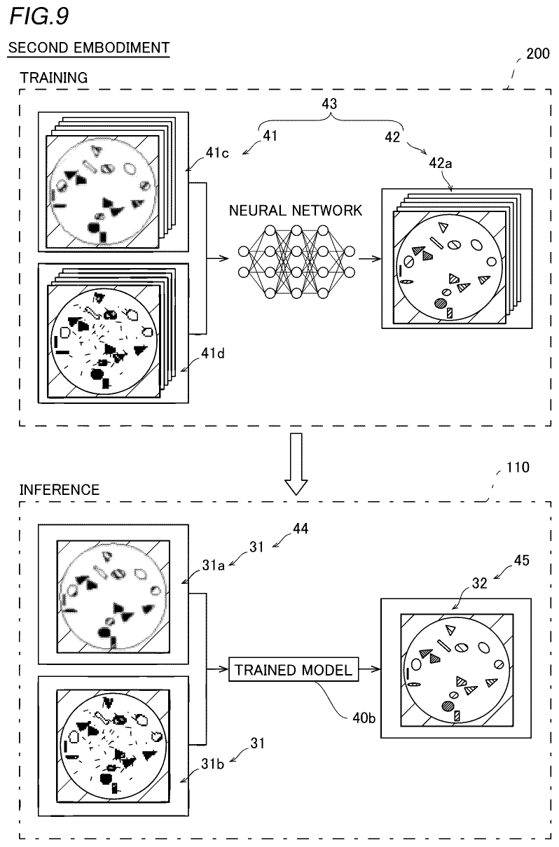

As shown in FIG. 9, the image processing unit 23 acquires corrected tomographic image data 32, in which the blur caused by the rotation of the subject 90 in the tomographic image data 31 with different degrees of noise is corrected, as output image data 45 by inputting a plurality of tomographic image data 31 with different degrees of noise as input image data 44 to the trained model 40b stored in the storage unit 24. In the second embodiment, the image processing unit 23 acquires the corrected tomographic image data 32, in which the blur caused by the rotation of the subject 90 in the tomographic image data 31 with different degrees of smoothing is corrected, as the output image data 45 by inputting a plurality of tomographic image data 31 with different degrees of smoothing as the input image data 44 to the trained model 40b. Specifically, the image processing unit 23 acquires the corrected tomographic image data 32, in which the blur caused by the rotation of the subject 90 in the first tomographic image data 31a and the second tomographic image data 31b is corrected, as the output image data 45 by inputting the first tomographic image data 31a with a high smoothing strength and the second tomographic image data 31b with a low smoothing strength as the input image data 44 to the trained model 40b.

That is, the image processing unit 23 acquires the corrected tomographic image data 32 as an output result (inference result) by inputting the first tomographic image data 31a and the second tomographic image data 31b as the input image data 44 to the trained model 40b.

Note that in the second embodiment, the plurality of tomographic image data 31 with different degrees of noise may be, for example, three or more types of tomographic image data 31 with different degrees of smoothing. In this case, the image processing unit 23 acquires the corrected tomographic image data 32 as the output image data 45 by inputting three or more types of tomographic image data 31 with different degrees of smoothing as the input image data 44 to the trained model 40b. Also, in the second embodiment, the plurality of tomographic image data 31 with different degrees of noise may be, for example, a plurality of tomographic image data 31 with different degrees of noise acquired by varying the reconstruction parameters in the reconstruction process.

### Trained Model and Trained Model Generation Method

The trained model 40b outputs corrected tomographic image data 32, in which the blur caused by the rotation of the subject 90 in the tomographic image data 31 with different degrees of noise is corrected, as output image data 45, when a plurality of tomographic image data 31 with different degrees of noise are input as input image data 44. In the second embodiment, the trained model 40b outputs the corrected tomographic image data 32 as the output image data 45 when the first tomographic image data 31a and the second tomographic image data 31b are input as the input image data 44.

The method for generating the trained model 40b comprises a step of acquiring a training image dataset 43 composed of input training data 41 including a plurality of tomographic image data (41c, 41d) of the subject 90 with different degrees of noise, acquired in a reconstruction process based on a plurality of rotational projection image data 30, and output training data 42 including tomographic image data 42a (ground truth image data) in which blur caused by the rotation of the subject 90 is corrected; and a step of generating, by machine learning based on the input training data 41 and the output training data 42, the trained model 40b that outputs corrected tomographic image data 32, in which the blur caused by the rotation of the subject 90 in the tomographic image data 31 is corrected, from the tomographic image data 31.

That is, in the second embodiment, the method for generating the trained model 40b comprises a step of acquiring a training image dataset 43 composed of input training data 41 including first tomographic image data 41c with a high smoothing strength and second tomographic image data 41d with a low smoothing strength, acquired by performing a reconstruction process based on a plurality of rotational projection image data 30, and output training data 42 including tomographic image data 42a (ground truth image data) in which blur caused by the rotation of the subject 90 is corrected; and a step of generating, by machine learning based on the input training data 41 and the output training data 42, the trained model 40b that outputs corrected tomographic image data 32, in which the blur caused by the rotation of the subject 90 in the first tomographic image data 31a and the second tomographic image data 31b is corrected, from the first tomographic image data 31a and the second tomographic image data 31b.

The first tomographic image data 41c and the second tomographic image data 41d in the input training data 41 include a set of a plurality of first tomographic image data 41c and second tomographic image data 41d. The plurality of first tomographic image data 41c and second tomographic image data 41d include blur caused by the rotation of the subject 90. Also, the tomographic image data 42a (ground truth image data) with corrected blur caused by the rotation of the subject 90 in the output training data 42 includes a plurality of tomographic image data 42a (ground truth image data) with corrected blur caused by the rotation of the subject 90 corresponding to each of the sets of the plurality of first tomographic image data 41c and second tomographic image data 41d in the input training data 41.

The trained model 40b is generated by machine learning using the input training data 41, which includes the first tomographic image data 41c with a high smoothing strength and the second tomographic image data 41d with a low smoothing strength, acquired by performing a reconstruction process based on a plurality of rotational projection image data 30, and the output training data 42, which includes the tomographic image data 42a (ground truth image data) with corrected blur caused by the rotation of the subject 90.

The first tomographic image data 41c and the second tomographic image data 41d in the input training data 41 may be the first tomographic image data 31a and the second tomographic image data 31b acquired by the image processing unit 23 of the X-ray imaging apparatus 100 and stored in the storage unit 24, or they may be first tomographic image data 31a and second tomographic image data 31b stored in the storage unit 24 of another X-ray imaging apparatus 100 or in the learning device 200.

The learning device 200 performs learning by machine learning, with the input training data 41 including the first tomographic image data 41c and the second tomographic image data 41d of the subject 90 as input, and the output training data 42 including the tomographic image data 42a (ground truth image data) with corrected blur caused by the rotation of the subject 90 as output, to generate the trained model 40b.

### CT Image Generation Method

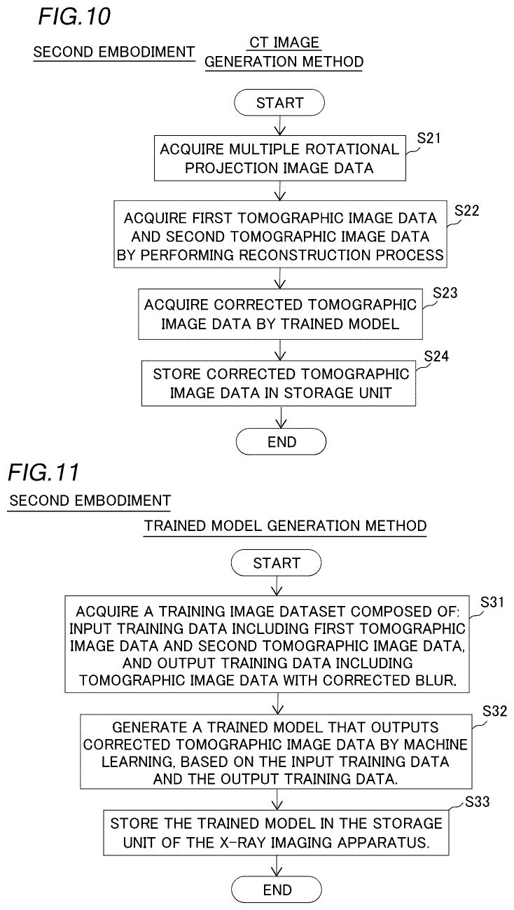

Next, with reference to FIG. 10, the CT image generation method by the control unit 21 in the second embodiment will be described. Note that the order of the processing steps can be changed or executed simultaneously as long as they do not contradict each other.

In step S21, the image processing unit 23 acquires a plurality of rotational projection image data 30, which are acquired by performing X-ray imaging by the imaging unit 5 while rotating the subject 90. Then, the process proceeds to step S22.

In step S22, the image processing unit 23 acquires first tomographic image data 31a and second tomographic image data 31b as two types of tomographic image data 31 with different degrees of smoothing in the reconstruction process based on the acquired plurality of rotational projection image data 30. Then, the process proceeds to step S23.

In step S23, the image processing unit 23 acquires corrected tomographic image data 32, in which the blur caused by the rotation of the subject 90 in the first tomographic image data 31a and the second tomographic image data 31b is corrected, as output image data 45 by inputting the first tomographic image data 31a and the second tomographic image data 31b as input image data 44 to the trained model 40b. Then, the process proceeds to step S24.

In step S24, the image processing unit 23 stores the acquired corrected tomographic image data 32 in the storage unit 24. Then, the process ends.

### Trained Model Generation Method

Next, with reference to FIG. 11, the method for generating the trained model 40b by the learning device 200 in the second embodiment will be described. Note that the order of the processing steps can be changed or executed simultaneously as long as they do not contradict each other.

In step S31, the learning device 200 acquires a training image dataset 43 composed of input training data 41 including first tomographic image data 41c with a high smoothing strength and second tomographic image data 41d with a low smoothing strength, acquired in a reconstruction process based on a plurality of rotational projection image data 30, and output training data 42 including tomographic image data 42a (ground truth image data) in which blur caused by the rotation of the subject 90 is corrected. Then, the process proceeds to step S32.

In step S32, the learning device 200 generates, by machine learning based on the input training data 41 and the output training data 42, the trained model 40b that outputs corrected tomographic image data 32, in which the blur caused by the rotation of the subject 90 in the first tomographic image data 31a and the second tomographic image data 31b is corrected, from the first tomographic image data 31a and the second tomographic image data 31b. Then, the process proceeds to step S33.

In step S33, the X-ray imaging apparatus 100 stores the trained model 40b generated by the learning device 200 in the storage unit 24 of the X-ray imaging apparatus 100. Then, the process ends.

### Comparison between Second Embodiment and Modification of Second Embodiment

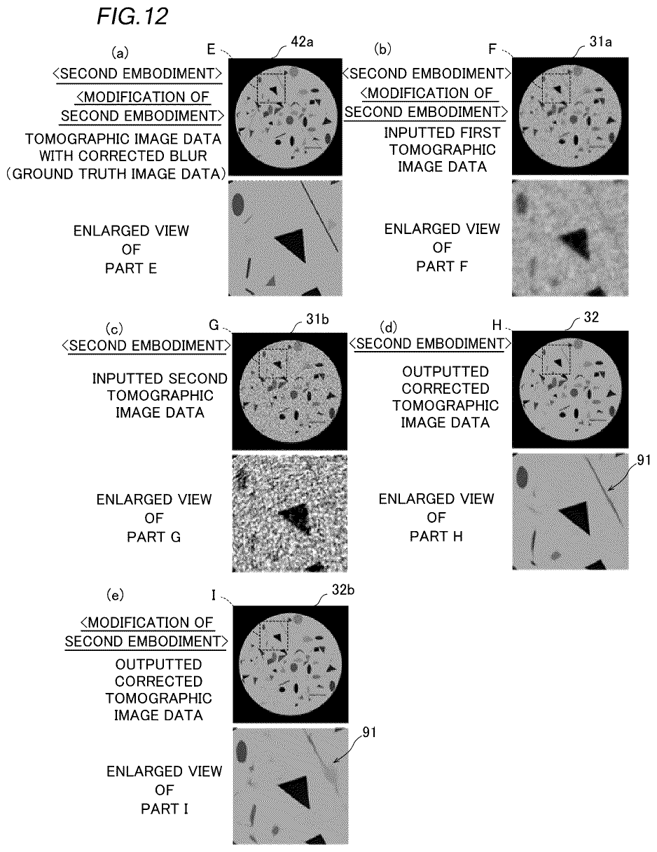

With reference to FIG. 9 and FIG. 12(a) to 12(e), a comparison result between the corrected tomographic image data 32 (CT image) acquired by the CT image generation method in the second embodiment and the corrected tomographic image data 32b (CT image) acquired by the CT image generation method in a modification of the second embodiment will be described.

The CT image generation method in the modification of the second embodiment, unlike the CT image generation method in the second embodiment shown in FIG. 9, acquires corrected tomographic image data 32b (see FIG. 12(e)) as output image data 45 by inputting only the first tomographic image data 31a as input image data 44 to the trained model, without inputting the second tomographic image data 31b. Also, the trained model in the modification of the second embodiment, unlike the CT image generation method in the second embodiment shown in FIG. 9, is generated by machine learning based on a training image dataset 43 composed of input training data 41 including the first tomographic image data 41c, without including the second tomographic image data 41d, and output training data 42 which is the tomographic image data 42a (ground truth image data) with corrected blur caused by the rotation of the subject 90. Note that the trained model in the modification of the second embodiment is an example of the “model” in the claims.

The subject 90 in the CT image generation method of the second embodiment and the subject 90 in the CT image generation method of the modification of the second embodiment are the same subject 90. The subject 90 is a cylindrical sample made of resin, and the interior of the subject 90 includes a material with a low X-ray 99 absorption coefficient or a gap.

The upper part of FIG. 12(a) is the tomographic image data 42a (ground truth image data) (see FIG. 9) with corrected blur caused by the rotation of the subject 90 in the second embodiment and the modification of the second embodiment, and the lower part of FIG. 12(a) is an enlarged view of portion E in the upper part of FIG. 12(a). The upper part of FIG. 12(b) is the first tomographic image data 31a (see FIG. 9) with a high smoothing strength in the second embodiment and the modification of the second embodiment, and the lower part of FIG. 12(b) is an enlarged view of portion F in the upper part of FIG. 12(b). The upper part of FIG. 12(c) is the second tomographic image data 31b (see FIG. 9) with a low smoothing strength in the second embodiment, and the lower part of FIG. 12(c) is an enlarged view of portion G in the upper part of FIG. 12(c). The upper part of FIG. 12(d) is the corrected tomographic image data 32 (see FIG. 9) of the second embodiment, and the lower part of FIG. 12(d) is an enlarged view of portion H in the upper part of FIG. 12(d). The upper part of FIG. 12(e) is the corrected tomographic image data 32b of the modification of the second embodiment, and the lower part of FIG. 12(e) is an enlarged view of portion I in the upper part of FIG. 12(e).

Comparing the lower part of FIG. 12(d) and the lower part of FIG. 12(e), it can be confirmed that the corrected tomographic image data 32 of the second embodiment shown in the lower part of FIG. 12(d) has the blur caused by the rotation of the subject 90 more corrected than the corrected tomographic image data 32b of the modification of the second embodiment shown in the lower part of FIG. 12(e). Also, it can be confirmed that the feature points 91 of the subject 90 are more accurately extracted in the corrected tomographic image data 32 of the second embodiment shown in the lower part of FIG. 12(d) than in the corrected tomographic image data 32b of the modification of the second embodiment shown in the lower part of FIG. 12(e). Therefore, it can be confirmed that the CT image generation method in the second embodiment can reduce the blur caused by the rotation of the subject 90 and extract the feature points 91 of the subject 90 more accurately in the tomographic image data at any cutting plane, compared to the CT image generation method in the modification of the second embodiment.

### Third Embodiment

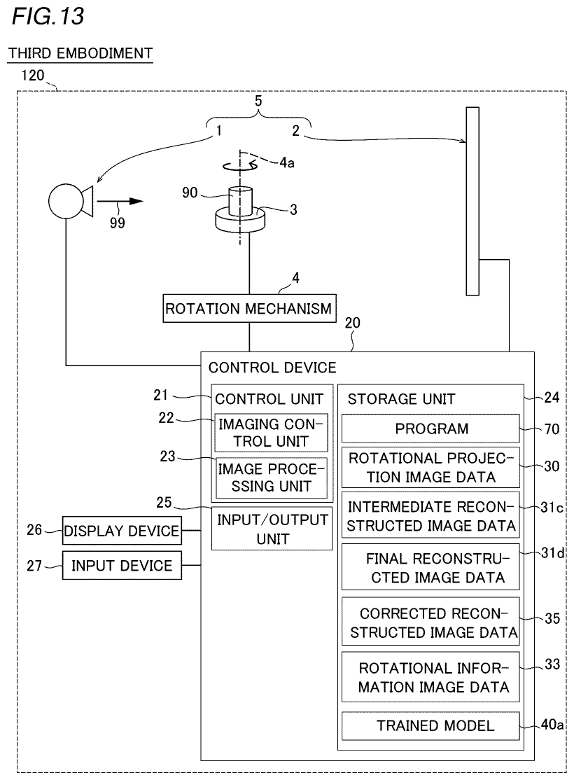

Next, with reference to FIGS. 13 to 16, a CT image generation method according to a third embodiment will be described. In the third embodiment, an example will be described in which, in the reconstruction process, intermediate reconstructed image data 31c is acquired by a reconstruction process at an intermediate stage, corrected reconstructed image data 35 is acquired from the acquired intermediate reconstructed image data 31c using a trained model 40a, and final reconstructed image data 31d is acquired by performing a reconstruction process on the acquired corrected reconstructed image data 35. In the third embodiment, components similar to those in the first embodiment described above are denoted by the same reference numerals, and a description thereof will be omitted.

The image processing unit 23 executes a reconstruction process using an iterative approximation method. In the reconstruction process using an iterative approximation method, as an example, calculation processing including forward projection, back projection, comparison, and updating is repeatedly performed at an intermediate stage. Specifically, in an example of the reconstruction process using an iterative approximation method, the calculation processing of (1) creating the k-th projection by calculation from the k-th image (intermediate reconstructed image data 31c) (forward projection), (2) finding the ratio of the k-th forward projection to the actually measured projection, (3) back-projecting the found ratio, and (4) updating to the (k+1)-th image (intermediate reconstructed image data 31c) by multiplying the k-th image by the back-projected image, is repeatedly performed at an intermediate stage of the reconstruction process.

In the reconstruction process, the image processing unit 23 performs the reconstruction process multiple times based on the acquired plurality of rotational projection image data 30, and acquires first intermediate reconstructed image data 31c by the reconstruction process at an intermediate stage.

Also, in the reconstruction process, the image processing unit 23 acquires first corrected reconstructed image data 35 from the acquired first intermediate reconstructed image data 31c using the trained model 40a. Specifically, when acquiring the first corrected reconstructed image data 35, the image processing unit 23 acquires the first corrected reconstructed image data 35, in which the blur caused by the rotation of the subject 90 in the first intermediate reconstructed image data 31c is corrected, as output image data 45 by inputting the first intermediate reconstructed image data 31c and the rotational information image data 33 as input image data 44 to the trained model 40a.

Also, in the reconstruction process, the image processing unit 23 acquires second intermediate reconstructed image data 31c by performing a reconstruction process on the acquired first corrected reconstructed image data 35. In the third embodiment, the image processing unit 23 acquires the second intermediate reconstructed image data 31c by performing the calculation processing in the reconstruction process by the iterative approximation method on the acquired first corrected reconstructed image data 35.

Also, the image processing unit 23 acquires second corrected reconstructed image data 35 as output image data 45 by inputting the second intermediate reconstructed image data 31c and the rotational information image data 33 as input image data 44 to the trained model 40a. Then, the image processing unit 23 acquires final reconstructed image data 31d by performing the calculation processing by the iterative approximation method on the acquired second corrected reconstructed image data 35.

In the third embodiment, the trained model is, as an example, a trained model 40a similar to the trained model 40a in the first embodiment described above. Note that the trained model in the third embodiment is not limited to a trained model 40a similar to the trained model 40a in the first embodiment. The trained model in the third embodiment may be, for example, the trained model 40b in the second embodiment. When the trained model is the trained model 40a in the first embodiment, the trained model 40a is generated by the method for generating the trained model 40a described in the first embodiment. When the trained model is the trained model 40b in the second embodiment, the trained model 40b is generated by the method for generating the trained model 40b described in the second embodiment.

Note that the trained model in the third embodiment is not limited to the trained model 40a in the first embodiment and the trained model 40b in the second embodiment. The trained model in the third embodiment may be a trained model configured to output corrected reconstructed image data 35, in which the blur caused by the rotation of the subject 90 in the intermediate reconstructed image data 31c is corrected, from the intermediate reconstructed image data 31c, by any of supervised learning, unsupervised learning, and reinforcement learning. Also, the machine learning method for the trained model in the third embodiment is not particularly limited. Also, the trained model in the third embodiment may be a generative AI (Artificial Intelligence). Note that the trained model in the third embodiment is an example of the “model” in the claims.

### CT Image Generation

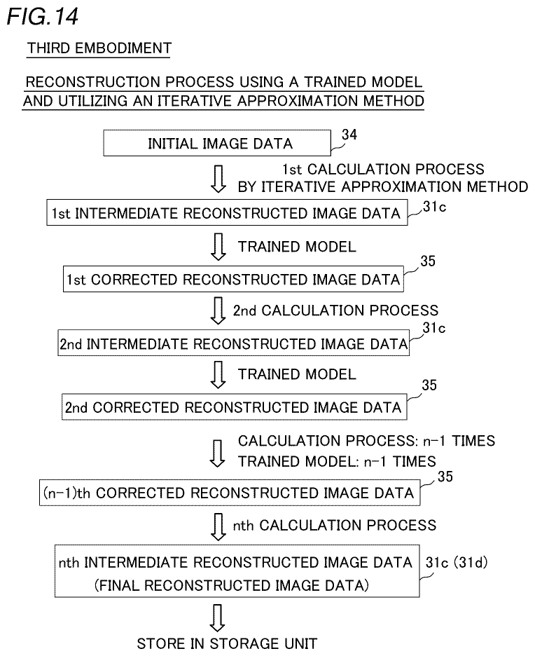

Next, with reference to FIG. 14, the CT image generation by the control unit 21 in the third embodiment will be described. Specifically, the reconstruction process using an iterative approximation method and using the trained model 40a by the control unit 21 will be described. Note that the image processing unit 23 executes the calculation processing of the reconstruction process using the iterative approximation method n times.

As shown in FIG. 14, the image processing unit 23 acquires a plurality of rotational projection image data 30 acquired by the detector 2 by performing X-ray imaging while rotating the subject 90.

The image processing unit 23 acquires first intermediate reconstructed image data 31c by executing the first calculation process in the reconstruction process using the iterative approximation method. Specifically, the image processing unit 23 acquires the first intermediate reconstructed image data 31c from initial image data 34 by executing forward projection, back projection, comparison, and updating as the first calculation process of the reconstruction process using the iterative approximation method.

The image processing unit 23 acquires first corrected reconstructed image data 35 as output image data 45 by inputting the first intermediate reconstructed image data 31c and the rotational information image data 33 as input image data 44 to the trained model 40a.

The image processing unit 23 acquires second intermediate reconstructed image data 31c from the first corrected reconstructed image data 35 by executing forward projection, back projection, comparison, and updating as the second calculation process of the reconstruction process using the iterative approximation method.

The image processing unit 23 acquires second corrected reconstructed image data 35 as output image data 45 by inputting the second intermediate reconstructed image data 31c and the rotational information image data 33 as input image data 44 to the trained model 40a.

Then, the image processing unit 23 repeatedly (iteratively) executes the calculation process of the reconstruction process and the input of the input image data 44 to the trained model 40a and the acquisition of the output image data 45. The image processing unit 23 repeatedly (iteratively) executes the calculation process of the reconstruction process and the acquisition of the output image data 45 using the trained model 40a n−1 times.

The image processing unit 23 acquires the n-th intermediate reconstructed image data 31c as final reconstructed image data 31d from the (n−1)-th corrected reconstructed image data 35 by executing forward projection, back projection, comparison, and updating as the n-th calculation process of the reconstruction process using the iterative approximation method. The image processing unit 23 stores the final reconstructed image data 31d, which is the n-th intermediate reconstructed image data 31c, in the storage unit 24.

### CT Image Generation Method

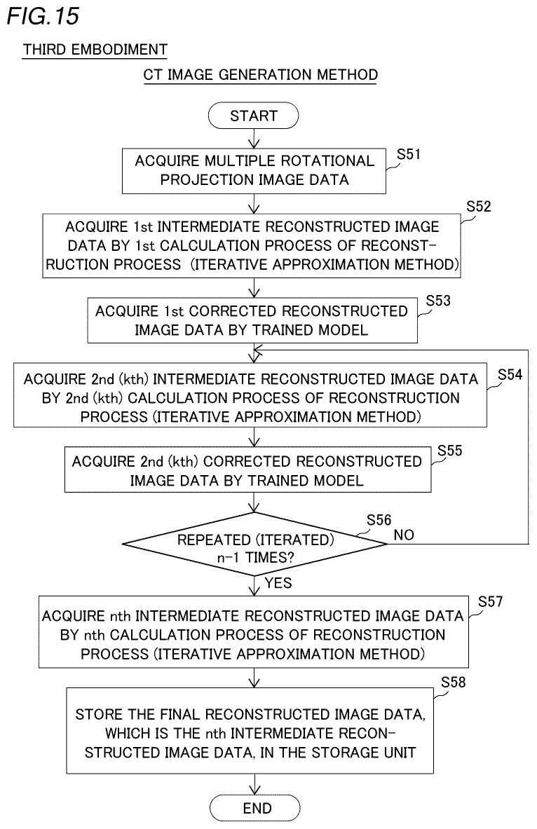

Next, with reference to FIG. 15, the CT image generation method by the control unit 21 in the third embodiment will be described. Note that the order of the processing steps can be changed or executed simultaneously as long as they do not contradict each other. Note that the image processing unit 23 executes the calculation processing of the reconstruction process using the iterative approximation method n times.

In step S51, the image processing unit 23 acquires a plurality of rotational projection image data 30, which are acquired by performing X-ray imaging by the imaging unit 5 while rotating the subject 90. Then, the process proceeds to step S52.

In step S52, the image processing unit 23 acquires first intermediate reconstructed image data 31c from initial image data 34 by executing the first calculation process in the reconstruction process using the iterative approximation method. Then, the process proceeds to step S53.

In step S53, the image processing unit 23 acquires first corrected reconstructed image data 35 as output image data 45 by inputting the first intermediate reconstructed image data 31c and the rotational information image data 33 as input image data 44 to the trained model 40a. Then, the process proceeds to step S54.

In step S54, the image processing unit 23 acquires second (n−1)-th intermediate reconstructed image data 31c from the first (n−2)-th corrected reconstructed image data 35 by executing the second (n−1)-th calculation process in the reconstruction process using the iterative approximation method. Then, the process proceeds to step S55.

In step S55, the image processing unit 23 acquires second (n−1)-th corrected reconstructed image data 35 as output image data 45 by inputting the second (n−1)-th intermediate reconstructed image data 31c and the rotational information image data 33 as input image data 44 to the trained model 40a. Then, the process proceeds to step S56.

In step S56, the image processing unit 23 determines whether or not the calculation process of the reconstruction process and the input of the input image data 44 to the trained model 40a and the acquisition of the output image data 45 have been repeatedly (iteratively) executed n-1 times. If the calculation process of the reconstruction process and the acquisition of the output image data 45 using the trained model 40a is n-1 times (Yes in step S56), the process proceeds to step S57. If the calculation process of the reconstruction process and the acquisition of the output image data 45 using the trained model 40a is less than n-1 times (No in step S56), the process proceeds to step S54.

In step S57, the image processing unit 23 acquires the n-th intermediate reconstructed image data 31c as final reconstructed image data 31d from the (n−1)-th corrected reconstructed image data 35 by executing forward projection, back projection, comparison, and updating as the n-th calculation process of the reconstruction process using the iterative approximation method. Then, the process proceeds to step S58.

In step S58, the image processing unit 23 stores the final reconstructed image data 31d, which is the n-th intermediate reconstructed image data 31c, in the storage unit 24. Then, the process ends.

### Effect of Final Reconstructed Image Data according to the Third Embodiment

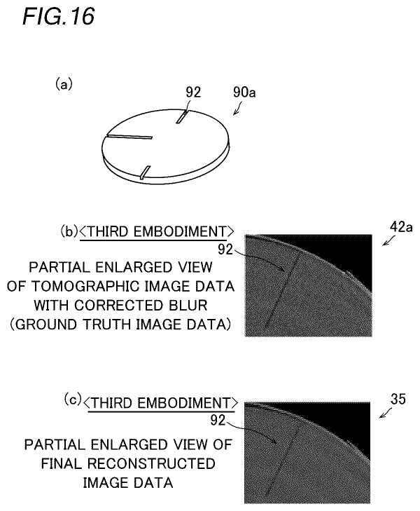

With reference to FIG. 3, FIG. 14, and FIG. 16(a) to 16(c), the effect of the final reconstructed image data 31d acquired by the CT image generation method in the third embodiment will be described.

FIG. 16(b) is the tomographic image data 42a (ground truth image data) with corrected blur caused by the rotation of the subject 90a in the third embodiment and a modification of the third embodiment. Also, FIG. 16(c) is a partially enlarged view of the final reconstructed image data 31d, which is the n-th intermediate reconstructed image data 31c of the third embodiment.

It can be confirmed that the final reconstructed image data 31d, which is the n-th intermediate reconstructed image data 31c of the third embodiment shown in FIG. 16(c), has the blur caused by the rotation of the subject 90 corrected. Therefore, it can be confirmed that the CT image generation method in the third embodiment can reduce the blur caused by the rotation of the subject 90 in the tomographic image data at any cutting plane.

### Modifications

It should be understood that the embodiments disclosed herein are illustrative in all respects and not restrictive. The scope of the present invention is indicated by the claims rather than by the description of the embodiments above, and all changes (modifications) within the meaning and scope equivalent to the claims are included.

For example, in each of the first to third embodiments, instead of using a trained model, unsupervised learning may be used to output an image in which blur caused by rotation has been corrected.

Also, in the first and second embodiments, volume data with corrected blur may be acquired and output using a plurality of output corrected tomographic image data.

Also, an embodiment that combines the first and second embodiments can be adopted. That is, by inputting a plurality of tomographic image data with different noise levels and rotational information image data into the model, it is also possible to output corrected tomographic image data in which the blur caused by the rotation of the subject has been even better corrected.

Similarly, in the third embodiment, an embodiment combining the first and/or second embodiments can be adopted. That is, in the third embodiment, (1) by inputting intermediate reconstructed image data and rotational information image data into the model, corrected reconstructed image data in which the blur caused by the rotation of the subject is corrected may be output, (2) by inputting a plurality of intermediate reconstructed image data with different noise levels into the model, corrected reconstructed image data in which the blur caused by the rotation of the subject is corrected may be output, or (3) by inputting a plurality of intermediate reconstructed image data with different noise levels and rotational information image data into the model, corrected reconstructed image data in which the blur caused by the rotation of the subject is corrected may be output.

Also, for example, in the first embodiment described above, the configuration may be such that the corrected tomographic image data is acquired even when the rotation speed of the subject in the rotational information image data is less than a predetermined threshold.

Also, for example, the configuration may be such that rotational projection image data is acquired while irradiating X-rays in pulses from an X-ray tube to a rotating subject.

### Aspects

It will be understood by those skilled in the art that the exemplary embodiments described above are specific examples of the following aspects.

### Item 1

A CT image generation method, comprising:
a step of acquiring a plurality of rotational projection image data by performing X-ray imaging while rotating a subject;
a step of acquiring tomographic image data by performing a reconstruction process based on the acquired plurality of rotational projection image data; and
a step of acquiring corrected tomographic image data, in which blur caused by the rotation of the subject in the tomographic image data is corrected, as output image data by inputting the tomographic image data as input image data to a model.

By inputting the tomographic image data, which is based on the rotational projection image data acquired by performing X-ray imaging while rotating the subject, as input image data to the model, it is possible to acquire corrected tomographic image data, in which the blur caused by the rotation of the subject in the tomographic image data is corrected, as output image data. Therefore, even if blur caused by the rotation of the subject occurs in the tomographic image data based on the rotational projection image data, by inputting the tomographic image data to the model, the corrected tomographic image data with the blur caused by the subject's rotation corrected is output from the model as the output result. Thus, it is possible to acquire corrected tomographic image data in which the blur caused by the subject's rotation is corrected. Therefore, it is possible to reduce the blur caused by the subject's rotation in the tomographic image data at any tomographic plane.

### Item 2

The CT image generation method according to item 1, further comprising a step of acquiring rotational information image data reflecting rotational information of the subject when acquiring the plurality of rotational projection image data,
wherein the step of acquiring the corrected tomographic image data acquires the corrected tomographic image data, in which the blur caused by the rotation of the subject in the tomographic image data is corrected, as the output image data by inputting the tomographic image data and the rotational information image data as the input image data to the model.

By inputting the tomographic image data and the rotational information image data reflecting the rotational information of the subject as input image data to the model, it is possible to acquire corrected tomographic image data in which the blur caused by the rotation of the subject is corrected. Therefore, compared to performing a deconvolution process or a filtering process on the tomographic image data, it is possible to acquire corrected tomographic image data in which the blur caused by the rotation of the subject is more corrected. Therefore, it is possible to further reduce the blur caused by the rotation of the subject in the tomographic image data at any tomographic plane.

### Item 3

The CT image generation method according to item 2, wherein the step of acquiring the rotational information image data acquires, as the rotational information image data, image data reflecting a rotation speed of the subject and a rotation angle of the subject between the plurality of rotational projection image data.

The rotation speed of the subject and the rotation angle of the subject between the plurality of rotational projection image data, which are known rotational information of the subject, are known rotational information of the subject set before acquiring the plurality of rotational projection image data or set as a fixed value of the X-ray imaging apparatus. Therefore, it is possible to easily acquire the rotational information image data based on the known rotational information of the subject.

### Item 4

The CT image generation method according to item 3, wherein the step of acquiring the rotational information image data acquires, as the rotational information image data, movement amount image data indicating a movement amount of each pixel in the tomographic image data, based on the rotation speed of the subject and the rotation angle of the subject between the plurality of rotational projection image data.

Since the movement amount image data indicating the movement amount of each pixel in the tomographic image data is input as input image to the model, it is possible to accurately acquire corrected tomographic image data in which the blur caused by the rotation of the subject is corrected as output image data.

### Item 5

The CT image generation method according to any one of items 2 to 4, wherein the step of acquiring the corrected tomographic image data is not executed when the rotation speed of the subject is less than a predetermined threshold, and is executed when the rotation speed of the subject is equal to or greater than the predetermined threshold.

When the rotation speed of the subject is less than a predetermined threshold, where the blur caused by the rotation of the subject is relatively small, the processing load can be reduced by not executing the process of acquiring corrected tomographic image data using the model. When the rotation speed of the subject is equal to or greater than the predetermined threshold, where the blur caused by the rotation of the subject is relatively large, by executing the process of acquiring corrected tomographic image data using the model, it is possible to acquire corrected tomographic image data in which the blur caused by the rotation of the subject is effectively corrected.

### Item 6

The CT image generation method according to any one of items 1 to 5, wherein the step of acquiring the tomographic image data acquires a plurality of the tomographic image data with different degrees of noise, and
the step of acquiring the corrected tomographic image data acquires the corrected tomographic image data, in which the blur caused by the rotation of the subject in the tomographic image data is corrected, as the output image data by inputting the plurality of tomographic image data with different degrees of noise as the input image data to the model.

By inputting a plurality of tomographic image data with different degrees of noise as input image data to the model, it is possible to acquire corrected tomographic image data in which the blur caused by the rotation of the subject is corrected, as output image data. Therefore, compared to inputting a single piece of tomographic image data, it is possible to acquire corrected tomographic image data in which the blur caused by the rotation of the subject is more corrected. Therefore, it is possible to further reduce the blur caused by the rotation of the subject in the tomographic image data at any tomographic plane.

### Item 7

The CT image generation method according to item 6, wherein the step of acquiring the tomographic image data acquires a plurality of the tomographic image data with different degrees of smoothing, and the step of acquiring the corrected tomographic image data acquires the corrected tomographic image data as the output image data by inputting the plurality of tomographic image data with different degrees of smoothing as the input image data to the model.

Since a plurality of tomographic image data with different degrees of smoothing are input as input image data for learning, it is possible to acquire, as output image data, corrected tomographic image data in which the blur caused by the rotation of the subject is accurately corrected and the feature points of the subject are accurately extracted. Therefore, in the tomographic image data at any tomographic plane, it is possible to reduce the blur caused by the rotation of the subject and accurately extract the feature points of the subject.

### Item 8

The CT image generation method according to any one of items 1 to 7, wherein the model is a trained model,
the method further comprises a step of generating the trained model, and
the step of generating the trained model generates, by machine learning based on input training data including the tomographic image data and output training data including tomographic image data in which the blur caused by the rotation of the subject in the tomographic image data is corrected, the trained model that outputs the corrected tomographic image data, in which the blur caused by the rotation of the subject in the tomographic image data is corrected, from the tomographic image data.

By inputting tomographic image data as input image data to the trained model generated by machine learning, it is possible to easily acquire corrected tomographic image data, in which the blur caused by the rotation of the subject in the tomographic image data is corrected, as output image data.

### Item 9

A CT image generation method, comprising:
a step of acquiring a plurality of rotational projection image data by performing X-ray imaging while rotating a subject;
a step of acquiring intermediate reconstructed image data by performing a reconstruction process multiple times based on the acquired plurality of rotational projection image data and by performing the reconstruction process at an intermediate stage;
a step of acquiring corrected reconstructed image data, in which blur caused by the rotation of the subject is corrected, from the acquired intermediate reconstructed image data using a model; and
a step of acquiring final reconstructed image data by further performing the reconstruction process using the acquired corrected reconstructed image data,
wherein the step of acquiring the corrected reconstructed image data acquires the corrected reconstructed image data, in which the blur caused by the rotation of the subject in the intermediate reconstructed image data is corrected, as output image data by inputting the intermediate reconstructed image data as input image data to the model.

By acquiring corrected reconstructed image data, in which blur caused by the rotation of the subject is corrected from the acquired intermediate reconstructed image data, using a model at an intermediate stage of a reconstruction process that is performed multiple times, it is possible to perform the reconstruction process on the corrected reconstructed image data, in which the blur caused by the rotation of the subject is corrected, at the intermediate stage of the reconstruction process. Therefore, as the final reconstructed image data, it is possible to acquire reconstructed image data in which the blur caused by the rotation of the subject is accurately corrected. Therefore, it is possible to further reduce the blur caused by the rotation of the subject in the tomographic image data at any tomographic plane.

### Item 10

The CT image generation method according to item 9, wherein the step of acquiring the intermediate reconstructed image data acquires the intermediate reconstructed image data by performing calculation processing in the reconstruction process by an iterative approximation method, and
the step of acquiring the final reconstructed image data acquires the final reconstructed image data by performing the calculation processing by the iterative approximation method on the acquired corrected reconstructed image data.

When performing the calculation processing by the iterative approximation method multiple times in the reconstruction process, by acquiring corrected reconstructed image data, in which the blur caused by the rotation of the subject is corrected from the intermediate reconstructed image data acquired by the calculation processing, using the model, it is possible to perform the calculation processing on the corrected reconstructed image data, in which the blur caused by the rotation of the subject is corrected, in the next calculation processing by the iterative approximation method. Therefore, as the final reconstructed image data, it is possible to easily acquire reconstructed image data in which the blur caused by the rotation of the subject is accurately corrected. Therefore, it is possible to more easily reduce the blur caused by the rotation of the subject in the tomographic image data at any tomographic plane.

### Item 11

A trained model generation method, comprising:
a step of acquiring a training image dataset composed of input training data including tomographic image data of a subject acquired by performing a reconstruction process based on a plurality of rotational projection image data, and output training data including the tomographic image data in which blur caused by the rotation of the subject is corrected; and
a step of generating, by machine learning based on the input training data and the output training data, a trained model that outputs corrected tomographic image data, in which the blur caused by the rotation of the subject in the tomographic image data is corrected, from the tomographic image data.

By using machine learning based on the input training data including the tomographic image data of the subject and the output training data including the tomographic image data in which the blur caused by the rotation of the subject is corrected, it is possible to learn image processing that corrects the blur caused by the rotation of the subject. Therefore, it is possible to easily generate a trained model that outputs corrected tomographic image data, in which the blur caused by the rotation of the subject in the tomographic image data is corrected, from the tomographic image data.

### Item 12

The trained model generation method according to item 11, wherein the step of acquiring the training image dataset acquires the training image dataset composed of the input training data including the tomographic image data of the subject and rotational information image data reflecting rotational information of the subject, and the output training data.

By using machine learning based on the input training data including the tomographic image data and the rotational information image data reflecting the rotational information of the subject, and the output training data, it is possible to learn image processing that corrects the blur caused by the rotation of the subject. Therefore, it is possible to easily generate a trained model that outputs corrected tomographic image data, in which the blur caused by the rotation of the subject in the tomographic image data is effectively corrected, from the tomographic image data.

### Item 13

The trained model generation method according to item 11, wherein the step of acquiring the training image dataset acquires the training image dataset composed of the input training data including a plurality of the tomographic image data of the subject with different degrees of noise, and the output training data.

By using machine learning based on the input training data including a plurality of tomographic image data of the subject with different degrees of noise, and the output training data, it is possible to learn image processing that corrects the blur caused by the rotation of the subject. Therefore, compared to the case of learning image processing by machine learning based on input training data consisting of a single piece of tomographic image data, it is possible to generate a trained model that outputs corrected tomographic image data, in which the blur caused by the rotation of the subject in the tomographic image data is effectively corrected, from the tomographic image data.

### Description of Symbols

30 Rotational projection image data
31, 41a Tomographic image data
31c Intermediate reconstructed image data
31d Final reconstructed image data
32 Corrected tomographic image data
33, 41b Rotational information image data
35 Corrected reconstructed image data
40a, 40b Trained model (Model)
41 Input training data
42 Output training data
42a Tomographic image data with corrected blur caused by subject rotation (ground truth image data)
43 Training image dataset
44 Input image data
45 Output image data
90 Subject

1. A CT image generation method, comprising:
a step of acquiring a plurality of rotational projection image data by performing X-ray imaging while rotating a subject;
a step of acquiring tomographic image data by performing a reconstruction process based on the acquired plurality of rotational projection image data; and
a step of acquiring corrected tomographic image data, in which blur caused by the rotation of the subject in the tomographic image data is corrected, as output image data by inputting the tomographic image data as input image data to a model.

2. The CT image generation method according to claim 1, further comprising a step of acquiring rotational information image data reflecting rotational information of the subject when acquiring the plurality of rotational projection image data,
wherein the step of acquiring the corrected tomographic image data acquires the corrected tomographic image data, in which the blur caused by the rotation of the subject in the tomographic image data is corrected, as the output image data by inputting the tomographic image data and the rotational information image data as the input image data to the model.

3. The CT image generation method according to claim 2, wherein the step of acquiring the rotational information image data acquires, as the rotational information image data, image data reflecting a rotation speed of the subject and a rotation angle of the subject between the plurality of rotational projection image data.

4. The CT image generation method according to claim 3, wherein the step of acquiring the rotational information image data acquires, as the rotational information image data, movement amount image data indicating a movement amount of each pixel in the tomographic image data, based on the rotation speed of the subject and the rotation angle of the subject between the plurality of rotational projection image data.

5. The CT image generation method according to claim 2, wherein the step of acquiring the corrected tomographic image data is not executed when the rotation speed of the subject is less than a predetermined threshold, and is executed when the rotation speed of the subject is equal to or greater than the predetermined threshold.

6. The CT image generation method according to claim 1,
wherein the step of acquiring the tomographic image data acquires a plurality of the tomographic image data with different degrees of noise, and
wherein the step of acquiring the corrected tomographic image data acquires the corrected tomographic image data, in which the blur caused by the rotation of the subject in the tomographic image data is corrected, as the output image data by inputting the plurality of tomographic image data with different degrees of noise as the input image data to the model.

7. The CT image generation method according to claim 6,
wherein the step of acquiring the tomographic image data acquires a plurality of the tomographic image data with different degrees of smoothing, and
wherein the step of acquiring the corrected tomographic image data acquires the corrected tomographic image data as the output image data by inputting the plurality of tomographic image data with different degrees of smoothing as the input image data to the model.

8. The CT image generation method according to claim 1,
wherein the model is a trained model,
wherein the method further comprises a step of generating the trained model, and
wherein the step of generating the trained model generates, by machine learning based on input training data including the tomographic image data and output training data including tomographic image data in which the blur caused by the rotation of the subject in the tomographic image data is corrected, the trained model that outputs the corrected tomographic image data, in which the blur caused by the rotation of the subject in the tomographic image data is corrected, from the tomographic image data.

9. A CT image generation method, comprising:
a step of acquiring a plurality of rotational projection image data by performing X-ray imaging while rotating a subject;
a step of acquiring intermediate reconstructed image data by performing a reconstruction process multiple times based on the acquired plurality of rotational projection image data and by performing the reconstruction process at an intermediate stage;
a step of acquiring corrected reconstructed image data, in which blur caused by the rotation of the subject is corrected, from the acquired intermediate reconstructed image data using a model; and
a step of acquiring final reconstructed image data by further performing the reconstruction process using the acquired corrected reconstructed image data,
wherein the step of acquiring the corrected reconstructed image data acquires the corrected reconstructed image data, in which the blur caused by the rotation of the subject in the intermediate reconstructed image data is corrected, as output image data by inputting the intermediate reconstructed image data as input image data to the model.

10. The CT image generation method according to claim 9,
wherein the step of acquiring the intermediate reconstructed image data acquires the intermediate reconstructed image data by performing calculation processing in the reconstruction process by an iterative approximation method, and
wherein the step of acquiring the final reconstructed image data acquires the final reconstructed image data by performing the calculation processing by the iterative approximation method on the acquired corrected reconstructed image data.

11. A trained model generation method, comprising:
a step of acquiring a training image dataset composed of input training data including tomographic image data of a subject acquired by performing a reconstruction process based on a plurality of rotational projection image data, and output training data including said tomographic image data in which blur caused by the rotation of the subject is corrected; and
a step of generating, by machine learning based on the input training data and the output training data, a trained model that outputs corrected tomographic image data, in which the blur caused by the rotation of the subject in the tomographic image data is corrected, from the tomographic image data.

12. The trained model generation method according to claim 11, wherein the step of acquiring the training image dataset acquires the training image dataset composed of the input training data including the tomographic image data of the subject and rotational information image data reflecting rotational information of the subject, and the output training data.

13. The trained model generation method according to claim 11, wherein the step of acquiring the training image dataset acquires the training image dataset composed of the input training data including a plurality of the tomographic image data of the subject with different degrees of noise, and the output training data.
